(19) United States
(12) Patent Application Publication
(10) Pub. No.: US 2017/0123451 A1
(43) Pub. Date: May 4, 2017

(54) AUDIO COMMUNICATIONS AND DISPLAY SYSTEM WORN ON THE HEAD OF A USER AND COMPRISING A RETRACTABLE NAPE SUPPORT DEVICE

(71) Applicant: THALES, Courbevoie (FR)

(72) Inventors: Joel BAUDOU, Saint Medard En Jalles (FR); Bruno Jouve, Talence (FR); Eric Rauscent, Lormont (FR)

(21) Appl. No.: 15/338,281

(22) Filed: Oct. 28, 2016

(30) Foreign Application Priority Data
Oct. 30, 2015 (FR) 1502292

(51) Int. Cl. G06F 1/16; G06F 3/01; H04R 1/02

(52) U.S. Cl. CPC G06F 1/163; H04R 1/028; G06F 3/012; H04R 2499/11

(57) ABSTRACT

The overall field of the invention is that of audio communications and display systems intended to be worn on the head of a user. The system according to the invention comprises:
a headband comprising two first arms each comprising an earpiece holder and an audio earpiece;
a sagittal bow support attached to the centre of the headband;
a display device mounted on the said sagittal bow;
a posture detection device mounted on the said sagittal bow;
a nape brace mounted on two articulated second arms in the region of the two audio earpieces so that the said nape brace occupies a raised first position that allows the user to put on or take off the audio communications and display system, and a lowered second position of use, in which the brace is situated at the level of the inion of the user's head.

The field of the invention is that of display systems worn on the head of a user. These systems in particular allow information to be displayed in superposition over the external landscape. They are notably known by their English name of “See-through HMD”, “HMD” being an acronym for “Head Mounted Display”. They may be monocular or binocular. They are used in various applications.

They are notably used in civilian and military aircraft cockpits to present the pilot with essential information regarding flight control or navigation. In this type of application they are associated with audio communications means also worn on the head of the user. In order to present information in a congruent position, which means to say at the exact location that this information occupies on the outside, it is necessary to know perfectly the orientation or posture of the display system in space. As a result, the display device is also associated with a posture detection system.

Display devices worn on the head are generally mounted on a helmet. The helmet is intended to afford protection against knocks and supports the audio communications function comprising the two earpieces and the microphone. The protective and communications helmet creates the interface with the head and is also used as a support for the display device. Such helmet-mounted display devices are currently reserved for the military or paramilitary domain.

Head-mounted display devices also offer benefits to general or commercial civilian aviation applications. In these civil applications, wearing a protective helmet is neither indispensable nor desirable. Specifically, a helmet takes up too much space in the cockpit. Moreover, it creates a feeling of hotness and isolation. Finally, for passengers to catch sight of a helmeted pilot may give the airlines problems with image. It is therefore necessary to use, as a support for the audio and visual means, a system of head straps which does not have the disadvantages of the helmet and which is less “present” on the head.

There also exist publicly available civilian augmented reality devices of the type known as the “see-through” type which are able to display flight information. These devices are generally goggles or facemasks. These very lightweight goggles and facemasks are not generally compatible with the wearing of eyeglasses. Furthermore, these systems do not have the level of performance required for aeronautical applications.

The audio communications headset forms part of the equipment and visual rules that civil aviation pilots have to adhere to. Mounting a compact and discreet display device on this audio headset adds a “connected” image that is acceptable to the pilot and the passengers. There are currently plans for such audio headsets comprising a display device for general public applications, but the performance of the display or posture detection device is not appropriate for aeronautical uses, particularly for reasons of the precision of the congruence of the images presented in relation to the actual landscape and of the reliability and visibility of this information.

A display and posture detection device intended for aeronautical use weighs at least 200 g. Once attached to the audio headset and positioned in front of the eye of the pilot, the mass and inertia of the display device causes the entire set to slip forward, leading to a visual loss of information. Increasing the tightness with which the audio headset is clamped on the head is not enough to avoid this slippage. The moment induced by this mass therefore has to be counterbalanced. This moment can be compensated for by pressure against the nose or the face. These latter solutions are not compatible or are barely compatible with the wearing of eyeglasses or sunglasses. This moment can also be compensated for by adding a balancing weight or a bearer on the back of the head. In order to be effective, the balancing weight or the bearer needs to lie at the base of the skull, at the level of the inion or the nape of the neck of the user. The solution a bearer against the nape of the neck is more lightweight and less tiring over long journeys than the balancing weight option. However, in the cockpit of a private aeroplane, for example, the space between the ceiling and the head may be a mere 50 mm. This space is not compatible with the height of an audio headset equipped with a nape brace and therefore forces the pilot to duck his head in order to wear one.

Moreover, the audio headset supply lead and the presence of wires between this headset and its earpieces constitute an impediment to placing the set on the head, with the risk of the wires becoming snagged or of loops of wire getting caught in uneven features of the cockpit such as switches or controls. This impediment is amplified by the presence of the supply lead for the display device mounted on the audio headset. With audio headsets, the earpiece supply wires are situated on the outside of the headband, at least in the region where the height of the earpieces is adjusted, where there is a loop of adjustment-allowance wire. This adjustment-allowance loop carries a risk of snagging when the headset is being put onto the head, and when moving around in the cockpit.

The system according to the invention does not have these disadvantages. It comprises a nape brace that can be raised in order to make the audio communications and display system easier to put on. More specifically, the subject of the invention is an audio communications and display system intended to be worn on the head of a user, the said audio communications and display system comprising:
a headband comprising two first arms of adjustable length, each arm comprising an earpiece holder and an audio earpiece;
a support attached to the headband;
a display device mounted on the said support;
a posture detection device mounted on the said support;

characterized in that the audio communications and display system comprises a nape brace mounted on two articulated second arms in the region of the two audio earpieces so that the said nape brace occupies a raised first position that allows the user to put on or take off the audio communications and display system, and a lowered second position of use, in which the brace is situated at the level of the inion of the user's head.

Advantageously, the support is a sagittal bow attached to the centre of the headband.

Advantageously, the nape brace is adjusted and tightened using a rack and pinion system, the pinion being turned by a knob situated in the region of the nape brace, each arm comprising a rack at its end.

Advantageously, the rack and pinion system is immobilized by a torsion spring arranged in the region of the pinion.

Advantageously, each articulated second arm comprises, in the region of its articulation to each first arm, a notched circular surface.

Advantageously, the support comprises a frontal bearer.

Advantageously, the audio communications and display system comprises a single input cable comprising several strands intended to power the audio earpieces, the display device and the posture detection device, the connection of the said cable to the audio communications and display system being made in the region of the base of one of the two earpiece holders, the said cable running along inside cable raceways through the headband and the sagittal bow, the said cable comprising an adjustment-allowance loop arranged inside a reservoir of the headband.

The invention will be better understood and further advantages will become apparent from reading the following description given by way of nonlimiting example and by studying the attached figures in which:

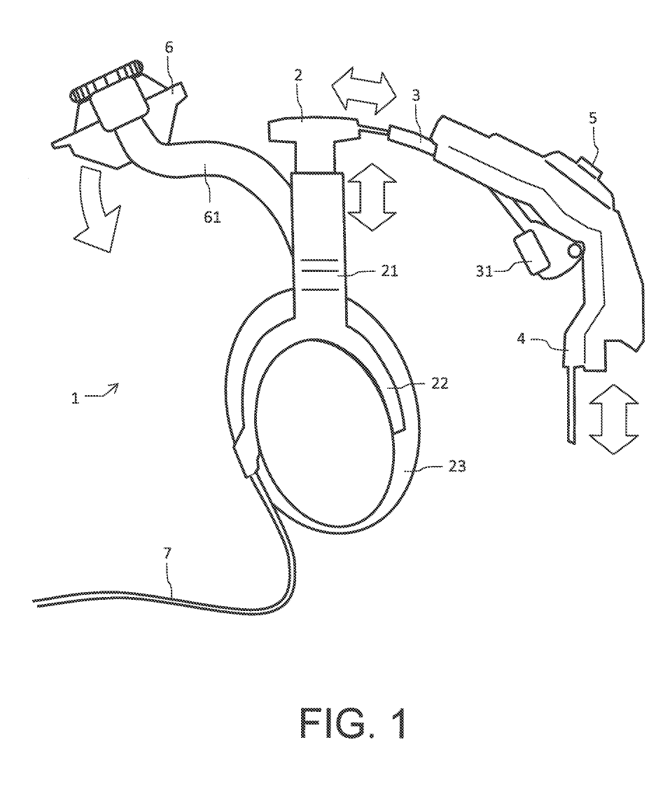

FIG. 1 depicts a side view of a display system according to the invention, the nape brace being in the raised position;

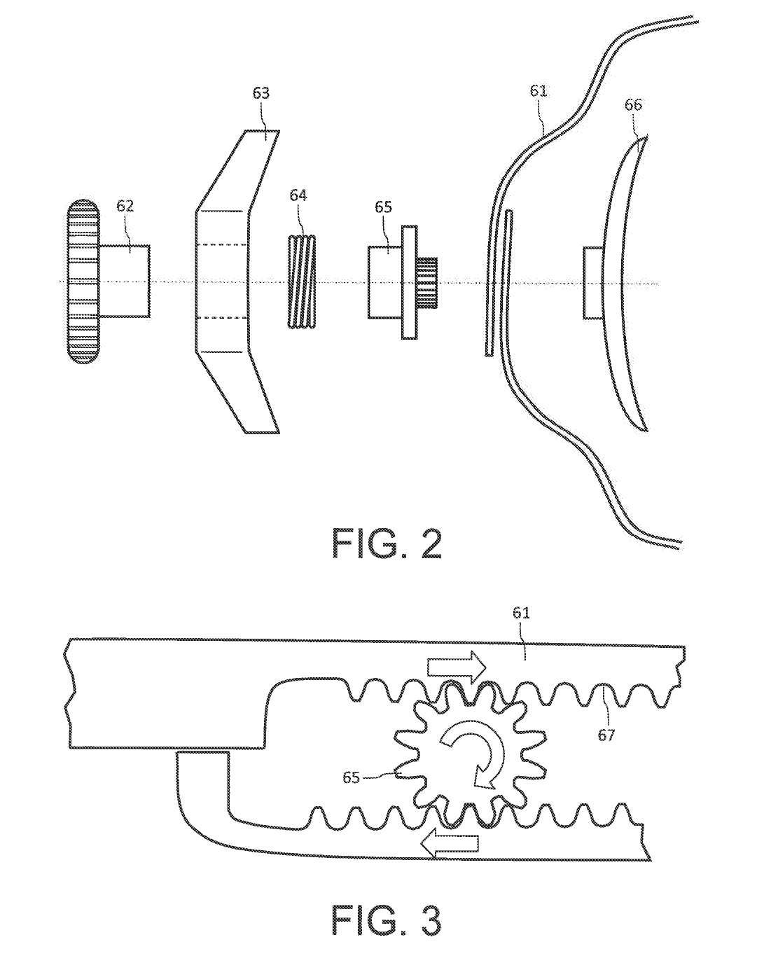

FIG. 2 depicts an exploded view of the assembly of the nape brace on its articulated arms;

FIG. 3 depicts a detailed view of the rack and pinion system used to tighten the nape brace;

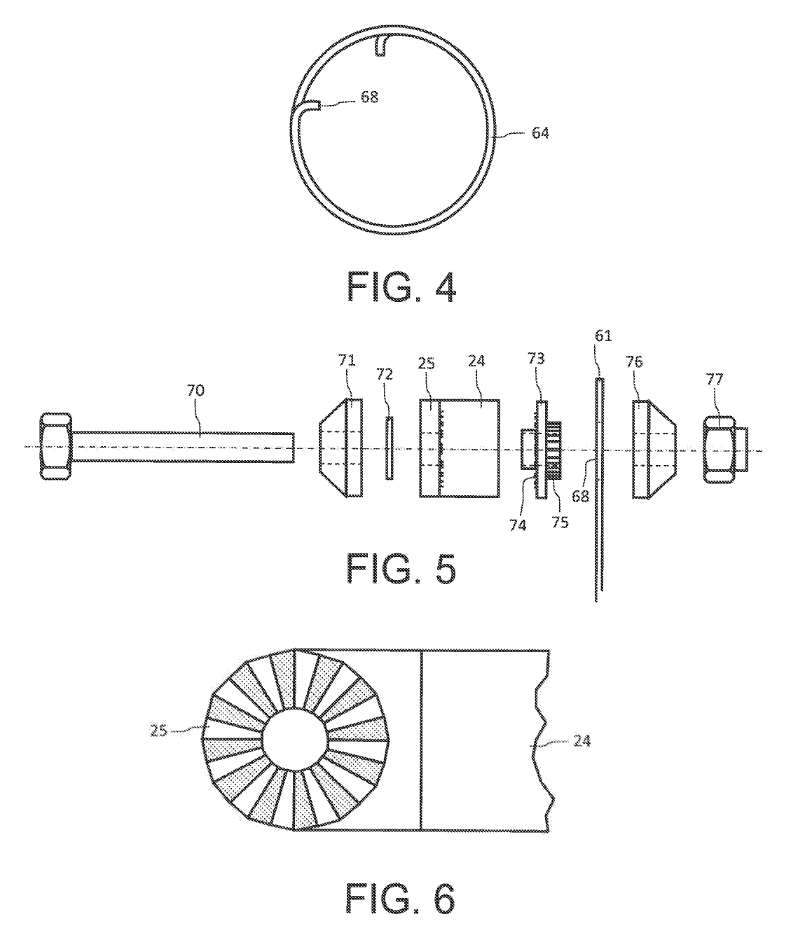

FIG. 4 depicts a detailed view of the torsion spring that immobilizes the nape brace;

FIG. 5 depicts an exploded view of the assembly of the articulation of the nape brace arms with the headband arms;

FIG. 6 depicts a partial view of the previous assembly; and

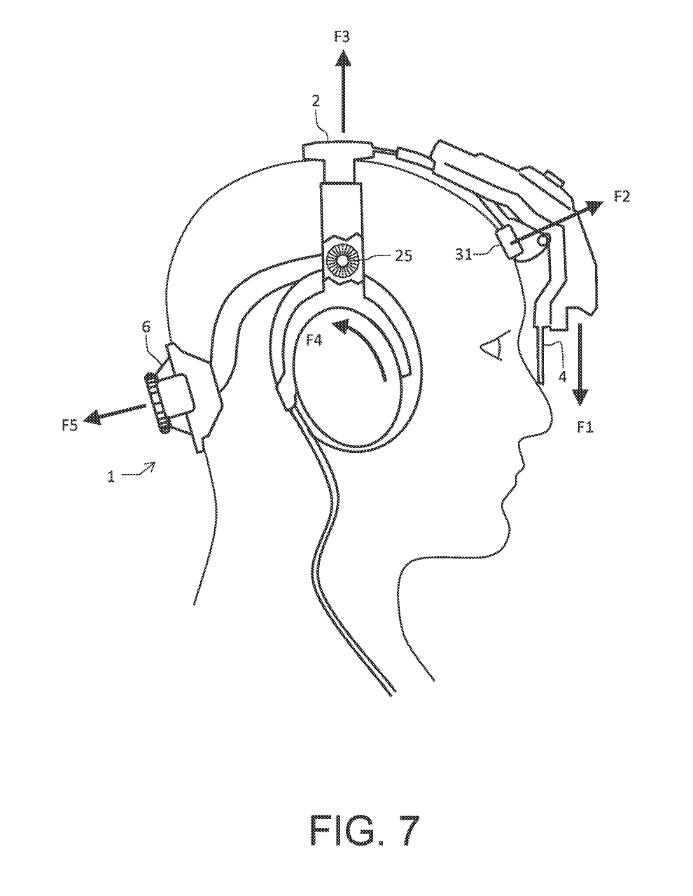

FIG. 7 depicts a side view of a display system according to the invention, mounted on the head of a user, the nape brace being in the lowered position.

By way of nonlimiting example, FIG. 1 depicts a side view of an audio communications and display system according to the invention, the nape brace being in the raised position. In this view, the arrows indicate the various directions of the adjustments and of the movements of the mechanical parts.

The audio communications and display system 1 comprises:
a headband 2 comprising two first arms 21, each arm comprising an earpiece holder 22 and an audio earpiece 23;
a support attached to the headband which, in the case of FIG. 1, is a sagittal bow 3 arranged at the centre of the headband. Other mechanical arrangements of the said support are possible. By way of example, it may be arranged to the side;
a display device 4 mounted on the said sagittal bow 3;
a posture detection device 5 mounted on the said sagittal bow;
a nape brace 6 mounted on two second arms 61 which are articulated at the region of the two audio earpieces;
a connecting cable 7.

The headband 2 comprises an elastic mechanical bow which at each of its ends bears an arm 21. The centre of the headband passes over the top of the head or vertex of the user. Each arm carries an earpiece holder 22 in the form of an articulated stirrup. Audio earpieces 23 are mounted in the stirrups 22. The various adjustments of the arms 21, of the stirrups 22 and of the earpieces 23, and the elasticity of the headband 2, allow the position of the earpieces to be adapted to suit the various morphologies of the users.

The sagittal bow 3 is attached to the centre of the headband. It bears a forehead bearer 31. This sagittal bow 3 carries the display device 4. In the case of FIG. 1, this display device is monocular. However, the system according to the invention can be adapted, with no major difficulty, to a binocular display device. This display device is adjustable so that the eye of the user is situated perfectly on the pupil of the display device. This display device conventionally comprises a small-sized display, collimation optics and an optical combiner positioned in front of the eye of the user and which superposes the image from the imager on the external landscape.

The headband, the sagittal bow or the display device also bear a posture detection device 5. There are various techniques for measuring the posture of the display device with respect to a known frame of reference. In the case of aeronautical applications, this frame of reference is that of the cockpit.

These posture detection systems may be hybrid systems. These then comprise an inertial sensor which operates at a high measurement frequency and an optical sensor which operates at a lower measurement frequency. The optical sensor makes it possible periodically to compensate for the temporal drift of the inertial sensor so as to have precise measurement at a high rate. The optical sensor comprises a first head-mounted subassembly comprising a microcamera and illuminating light emitting diodes, and a second subassembly consisting of a collection of optical test patterns arranged in the known frame of reference. This frame of reference is that of the cockpit in the case of aeronautical applications.

The nape brace 6 is mounted on two second arms 61 which are articulated in the region of the two audio earpieces. FIG. 2 depicts an exploded view of the assembly of the nape brace 6 on its articulated arms 61. The mechanical assembly of the nape brace comprises, in this order, an adjusting knob 62, a knob support 63, a torsion spring 64, a driving pinion 65 and a nape rest 66 intended to lie against the nape of the neck of the user.

The ends of each articulated arm 61 are arranged between the driving pinion 65 and the nape rest 66. As may be seen in FIG. 3 which depicts a partial view of the ends of the articulated arms, these ends have an opening 67 that is toothed so as to constitute a rack with the driving pinion 65. In order to tighten or loosen the articulated arms, it is sufficient to turn the adjusting knob 62 which turns the pinion 65 which tightens or loosens the articulated arms by means of their respective racks. In FIG. 3, the white arrows indicate the movement of the articulated arms.

The adjustment is maintained by the torsion spring 64. It is depicted in a front view in FIG. 4. It has two ends 68 in the form of strands. When the arms are under tension, the driving pinion 65 acts on the strands of the torsion spring. The spring unwinds, its diameter increases and it then becomes jammed in a bore of the knob support 63, thus preventing the articulated arms from relaxing. When the knob acts on the strands of the spring, the spring is wound up, its diameter decreases, and it slides in the bore of the knob support 63. With turning, the strands of the spring drive the pinion 65.

FIG. 5 depicts an exploded view of the assembly of one of the articulated arms 61 in the earpiece holders 21. This mechanical assembly comprises, in this order, a screw of axis 70, a first bearing washer 71, an elastic washer 72, a first mechanical component 24 attached to the arm 21 of one of the audio earpieces, a second mechanical component 73 comprising a notched surface 74 and a toothed surface 75, the end of the articulated arm 61, a second bearing washer 76 and finally the lock nut 77 which locks the assembly on the screw of axis 70.

FIG. 6 depicts a partial front view of the first mechanical component 24. It comprises a notched surface 25. The notches are depicted in this FIG. 6 as parts that are alternately white and grey. This notched surface 25 becomes lodged in the notches of the notched surface 74 of the component 73.

The component 61 comprises a housing 68 comprising the same hollow indentations as the toothed surface 75 so that the rotational movement of the arm 61 causes the second mechanical component 73 to turn.

The nape brace is held in position by the pressure applied by the elastic washer 72 to the notched surfaces 74 and 25. When the nape brace is lowered or raised, the notched surface 74 is pushed back along the screw of axis 70 by the notches of the surface 25. Adjusting the pressure exerted by the elastic washer 72 and by the lock nut 77 makes it possible to adjust the amount of resistive torque that holds the nape brace in position.

The cable 7 is attached to the lower rear part of the right-hand earpiece holder 22. It comprises several strands providing power to the earpieces, the posture detection means, and finally the display of the display device. The strands run inside the audio communications and display system along the following path:
they enter the earpiece holder 22;
inside the earpiece holder 22, they pass through a vertical pivot. This pivot is slotted for mounting the cable equipped with its connectors at each end;
they pass through the arm 21. The strands of the cable are protected in the region in which the height of the earpieces can be adjusted by a first cable raceway made of flexible plastic and of trapezoidal cross section that provides it with flexibility;
they pass through the headband 2. The adjustment-allowance loop of cable strands is protected in a “reservoir” formed by the surface that rests on the top of the head and the cable protection cable raceway;
the strands of the cable pass under the sagittal bow 3. The strands are protected by a second cable raceway in the region of “telescopic” adjustment of the position of the display device. This adjustment through sliding along an arc of a circle allows a combined longitudinal and vertical movement of the frontal bearer and of the position of the display device;
the cable passes through the yoke articulating the display device 4 to the sagittal bow 3. The connectors connecting the display device are situated on the inside of the display device in order to afford them some protection.

FIG. 7 depicts a side view of a display system 1 according to the invention mounted on the head of a user, the nape brace 6 being in the lowered position. This figure comprises a partial cross section in the region of the earpiece holder arms, showing the notched surface 25. The articulation of the nape brace is immobilized by this notched surface. In this figure, the black arrows F1 to F5 represent the various forces and moments exerted on the system by the head of the user.

The arrow F1 represents the weight of the display device 4. This force is vertical. The arrow F2 represents the component of the grip of the frontal bearer that opposes the weight and opposes the turning moment of the display device and the tightening of the nape brace 6. The arrow F3 represents the force exerted by the top support of the headband 2 opposing the weight and turning moment of the display device. The curved arrow F4 represents the turning moment that opposes that of the display device. It is created by the elasticity of the headband and the grip of the earpieces. The arrow F5 represents the component of the grip of the nape brace 6 that opposes the weight and turning moment of the display device. These various forces and turning moments balance. Thus, the headset is perfectly fixed on the head of the user, without the risk of moving.

One of the key advantages of this solution is that it is compatible with the wearing of eyeglasses by the user. Another of these advantages is that the audio communications and display system is quick and easy to put on. Furthermore, the overall ergonomics of the system remain those of a conventional audio headset with earpieces. Finally, the system overall maintains a reasonable size and weight.

1. Audio communications and display system intended to be worn on the head of a user, the said audio communications and display system comprising:
a headband comprising two first arms of adjustable length, each arm comprising an earpiece holder and an audio earpiece;
a support attached to the headband;
a display device mounted on the said support;
a posture detection device mounted on the said support;
wherein the audio communications and display system comprises a nape brace mounted on two articulated second arms in the region of the two audio earpieces so that the said nape brace occupies a raised first position that allows the user to put on or take off the audio communications and display system, and a lowered second position of use, in which the brace is situated at the level of the inion of the user's head.

2. Audio communications and display system according to claim 1, wherein the support is a sagittal bow attached to the centre of the headband.

3. Audio communications and display system according to to claim 1, wherein the nape brace is adjusted and tightened using a rack and pinion system, the pinion being turned by a knob situated in the region of the nape brace, each arm comprising a rack at its end.

4. Audio communications and display system according to claim 3, wherein the rack and pinion system is immobilized by a torsion spring arranged in the region of the pinion.

5. Audio communications and display system according to claim 1, wherein each articulated second arm comprises, in the region of its articulation to each first arm, a notched circular surface.

6. Audio communications and display system according to claim 1, wherein the support comprises a frontal bearer.

7. Audio communications and display system according to claim 1, wherein the audio communications and display system comprises a single input cable comprising several strands intended to power the audio earpieces, the display device and the posture detection device, the connection of the said cable to the audio communications and display system being made in the region of the base of one of the two earpiece holders, the said cable running along inside cable raceways through the headband and the sagittal bow, the said cable comprising an adjustment-allowance loop arranged inside a reservoir of the headband.
